(19) United States
(12) Patent Application Publication
(10) Pub. No.: US 2016/0342584 A1
(43) Pub. Date: Nov. 24, 2016

(54) Method and Apparatus for Social Relation Analysis and Management

(71) Applicant: Nokia Technologies Oy, Espoo (FI)

(72) Inventors: Wenwen HAN, Beijing (CN); Ye TIAN, Beijing (CN); Wendong WANG, Beijing (CN); Jian MA, Wuxi, Jiangsu (CN)

(21) Appl. No.: 15/111,246

(22) PCT Filed: Jan. 27, 2014
(86) PCT No.: PCT/CN2014/071590

§ 371 Date: Jul. 13, 2016

(51) Int. Cl. G06F 17/27; G06Q 50/00

(52) U.S. Cl. CPC G06F 17/2785; G06Q 50/01

(57) ABSTRACT

An approach is provided for analyzing social relation in an aspect of polarity. A method comprises collecting data associated with interactions between a first user and a second user in a social network; and estimating a polarity of a social relation between the first user and the second user based on the collected data, to indicate whether the social relation between the first user and the second user is positive, negative, or neutral.

### FIELD OF THE INVENTION

The present invention generally relates to analysis and management of social relation in a social network. More specifically, the invention relates to analyzing relationships between users by measuring polarity of social interactions between the users in social network services.

### BACKGROUND

Web is developing at a rapid pace, which largely changes the manner of information sourcing and information sharing for people. One obvious improvement is that, Internet has brought the sourcing and sharing operations from an off-line life to an online life. Currently, through web services, a user could not only subscribe to a source account, such as a public account of company, organization or individual, but also could post opinions and feelings on the source account reversely. The interactions between two accounts are important, because it contains inter-attitudes between each other, no matter explicit opinions expressed by words, or implicit opinions expressed by certain operations, which are valuable clues in social relation analysis.

The traditional method for analyzing user relations fails in the newly emerging scenario of interactions. For example, a social link between two users usually only shows that they are connected. However, it could not demonstrate whether the social link is positive or negative. To illustrate, as a company manager, you won't know whether an associated user is a supporter or an objector. Moreover, you won't either know whether the interactions show intimacy or hostility. However, this orientation of social relation is important and beneficial to business owners, because it shows the direct and indirect feedback of your customers, the clusters of potential loyal customers and lost customers, etc.

A key idea of traditional analysis method of social relation is to estimate the interaction frequency between two users. For example, conversation, messages, comments, replies to questions are all interactions. However, a tight relation doesn't mean good relations, and thus only measuring frequency may cause a misunderstanding of a social relation. Thus, it would be advancement in the art to analyze an orientation of social relation so as to measure inter-attitudes between users.

### SOME EXAMPLE EMBODIMENTS

To overcome the problem described above, and to overcome the limitations that will be apparent upon reading and understanding the prior arts, the disclosure provides an approach for detecting malwares offline and/or at runtime effectively and efficiently.

According to one embodiment, a method comprises collecting data associated with interactions between a first user and a second user in a social network; and estimating a polarity of a social relation between the first user and the second user based on the collected data, to indicate whether the social relation between the first user and the second user is positive, negative, or neutral.

In an exemplary embodiment, a polarity of at least one of texts and operations involved the interactions may be identified for estimating the polarity of the social relation. Sentiment words may be extracted from the texts involved in the interactions, and then a polarity of each of the extracted sentiment words may be identified. The identified polarities of sentiment words may be synthesized to derive a polarity of whole interaction data. Operations may be extracted from the interactions, and then a polarity of each of the operations may be identified. The identified polarities of operations may be synthesized to derive a polarity of whole interaction operations. The polarity of the social relation may be estimated by combining the synthesized polarity of sentiment word and the synthesized polarity of operation.

In an exemplary embodiment, the polarity of the social relation is estimated to further indicate the strength of the polarity of the social relation.

In an exemplary embodiment, the method may further comprise managing the social relation between the first user and the second user based on the estimated polarity of the social relation.

According to another embodiment, an apparatus comprising at least one processor, and at least one memory including computer program code, the at least one memory and the computer program code configured to, with the at least one processor, cause, at least in part, the apparatus to collect data associated with interactions between a first user and a second user in a social network; and estimating the polarity of the social relation based on the identified polarity.

According to another embodiment, a computer-readable storage medium carrying one or more sequences of one or more instructions which, when executed by one or more processors, cause, at least in part, an apparatus to perform one of the methods discussed above.

According to another embodiment, an apparatus comprises means for performing one of the methods discussed above.

A computer program product including one or more sequences of one or more instructions which, when executed by one or more processors, cause an apparatus to at least perform one of the methods discussed above.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details may be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 illustrates a traditional analysis of social relation based on user interactions;

FIG. 2 illustrates a schematic block diagram of a system for social relation analysis and management according to an embodiment;

FIG. 3 is a flow diagram illustrating an outline of a procedure for social relation analysis and management, according to some embodiments of the present invention;

FIG. 4 illustrates a management and visualization of social relation in a polarity aspect, according to some embodiments of the present invention; and

FIG. 5 illustrates an example block diagram of an apparatus in which various exemplary embodiments of the present invention may be applied.

### DETAILED DESCRIPTION OF THE INVENTION

Examples of a method, apparatus, system and computer program for analyzing and managing a social relation between users by measuring a polarity of the social relation are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

The problems of social relation estimation mainly stem from two aspects, including an application aspect and a computation aspect. In the application aspect, as the overwhelming online contents and interactions emerge at an unimaginable fast speed each day, it is become increasingly impossible for a public account to maintain and distinguish the large amount of social relations between users efficiently in a manual way. New management and visualization methods for social relations are in an urgent need. In the computation aspect, the traditional ways of social relation estimation are both inadequate and incorrect concerning the new requirements of fine-grained recognition for social relations. Specifically, in a traditional social relation analysis, interactions are always used to measure the intimacy of two users. Intuitively, it is assumed that the more interactions happened between two users, the more close the two users are. However, this assumption could cause a misunderstanding in the social relation analysis, because a tight relation (i.e. frequent interactions) between two users may not mean a good relation between them. In the real world, tight interactions could be greetings and blessings; however, they could also be quarrelling or disputations. So, it is hard to get a fine-grained and accurate understanding of social relations, for example, to determine whether it is a good relation or bad relation between two users.

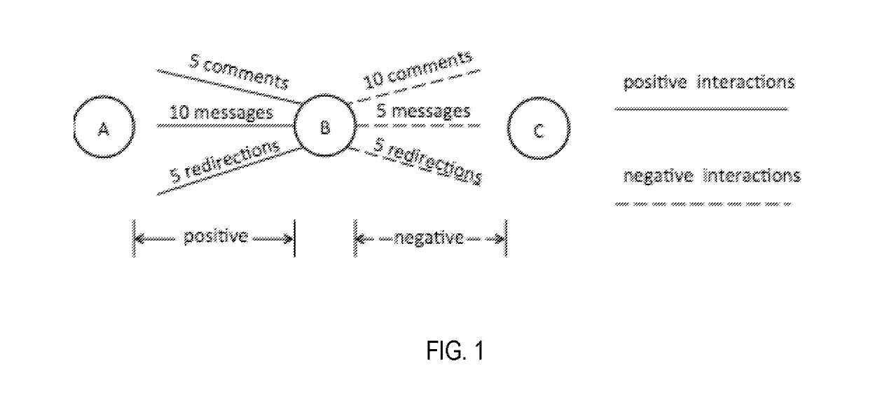

The following illustrates a concrete example of the problem in the computation aspect. In FIG. 1, a solid line means sending positive texts or performing positive operations, such as greetings or vote operations, while a dash line means giving negative texts or performing negative operations, such as scolding or against ideas. A concrete scenario may be like that: a user A and a user B are lovers, they always chat with each other, comment on new published statuses, and redirect interesting contents to each other. Thus, their online interactions are quite frequently, which may be calculated as 5+10+5=20. In contrast, While, the user B and a user C are opponent for each other, which means they don't quite agree on some topics, events, and they may have launched a large and long-lasting quarrel in online platform. Their interactions are also frequent, which may be also equals to 10+5+5=20.

From the aspect of frequency, the two relations (A with B, and B with C) are exactly the same, with both quantities as 20. However, we cannot conclude that the relation between the user A and the user B is same as the relation between the user B and the user C. This is because, the interactions between the user A and the user B are positive, while the interactions between the user B and the user C are negative. Therefore, estimating user relations only based on the frequency of interactions will cause a misunderstanding or inadequate understanding of the user relations. This may bring a bad effect on services based on social relations, for example recommendation services and business intelligence services.

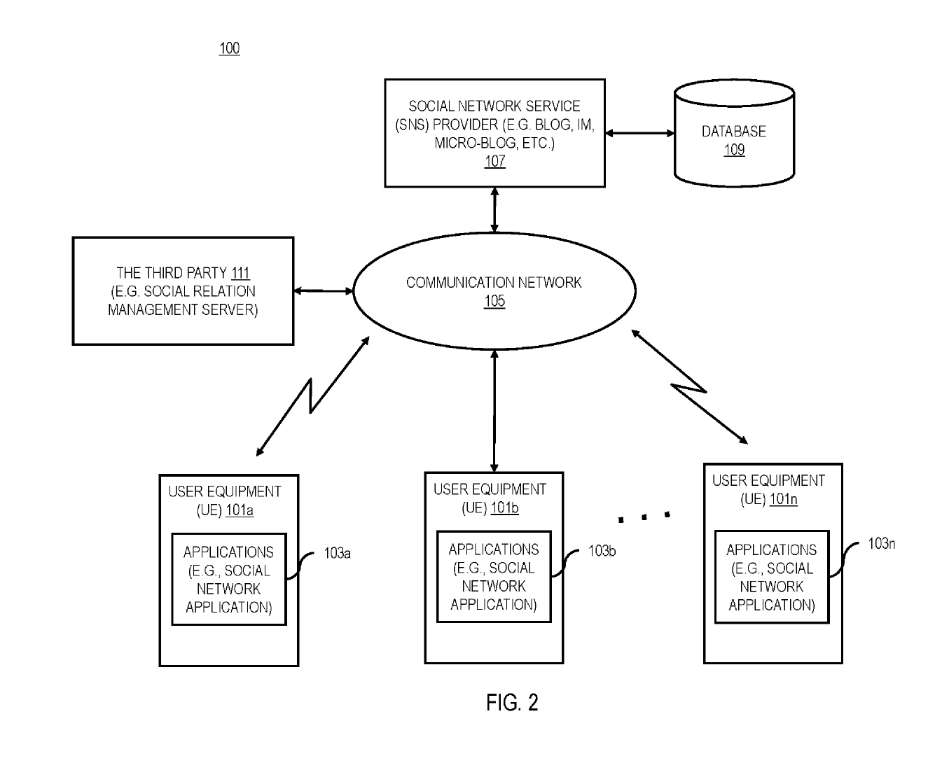

According to various exemplary embodiments, a fine-grained and accurate understanding of social relations may be provided by measuring user relations in polarity aspect. The “polarity” is estimated from “orientations” of interactions, for example, indicating whether a social relation between two individual users is positive, negative, or neutral. Referring to FIG. 2, a system 100 is depicted for analyzing and management social relation in a social network, according to an exemplary embodiment. As shown in FIG. 2, the system 100 comprises user equipment (UE) 101 having connectivity to a social network service (SNS) provider 107, other UEs 101 and other communication entities (such as a third party 111) via a communication network 105.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), a self-organized mobile network, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), wireless local area network (WLAN), Long Term Evolution (LTE) networks, code division multiple access (CDMA), wideband code division multiple access (WCDMA), wireless fidelity (WiFi), satellite, mobile ad-hoc network (MANET), and the like.

The UE 101 may be any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.). As shown in FIG. 1, user equipment (UEs) 101a-101n may be utilized to perform social network applications 103a-103n. These social network applications 103 may utilize a communication network 105 to communicate to t other UEs, the SNS provider 107 and other communication entities (e.g. a third party 111), for performing social network services.

The social network service (SNS) provider 107 may store user information (e.g. profiles) and other data in a database 109, for providing social network services, such as micro-blogs, blogs, a messaging communication, telephone communications, social network games, etc. Although only one SNS provider is shown in FIG. 2, any numbers of SNS providers may be provided, for providing various social network services.

In some embodiments, the SNS provider 107 may further analyze historical behaviors of a user of the UE 101, for analyzing and managing the social relation of the user. In some embodiments, a third party 111, such as a particular server, may be provided for collecting data of historical social behaviors of a user from the SNS provider 107, and analyzing and managing the social relation of the user based on the collected data. In other embodiments, the social relation analysis and management of a user may be performed in the UE 101 of the user, for example, by utilizing the social networking applications. In this regard, a polarity of a social relation between two users may be estimated based on various interactions between the two users. Data associated with these interactions may be collected from various social services that the two users participated. For example, comments, messages, redirections, supports, or disagreements, or the like, may be collected from online social services.

Interactions between two users may fall into two categories: pure texts and mutual operations. Polarities information can be identified with respect to respective texts and operations. For example, natural language processing, text analysis or computational linguistics, or the like, may be used to identify and extract subjective information in interactive texts. Based on the subjective information, the attitude of a speaker or a writer may be determined. In an example, a given interaction text may be analyzed by classifying its polarity at a document, sentence, or feature/aspect level,—whether the expressed attitude in a document, a sentence or an entity feature/aspect is positive, negative, or neutral. Interactive operations may also be analyzed to explore the attitude hidden behind the interactive operations, such as “cancelling a relation”, “supporting the content of a user”, “deleting the content of a user” etc. It is quite possible that no positive words or negative words are expressed between two users, but they do share polaritive relations, since they vote for or against each other, adding, deleting or redirecting co-related content, follow interested topics, etc. Thus, a polarity of social relation may be measured by analyzing interaction texts and operations. Moreover, texts and operations may be given a positive or negative sentiment strength score.

The polarities of texts and operations may be combined for determining the overall polarity of the social relation between users. For example, all of the text polarities and operation polarities may be combined together as a single linear equation, to predict the social polarity between two users. Moreover, a polarity strength may be further measured through the combination, to estimate that to what degree the relation is positive or negative. The measurement results may be displayed to facilitate user relation management. Furthermore, it is helpful to support services (for example to make a recommendation) based on these fine-grained and accurate measurement results. As such, social relations between users could be automatically collect, analyze, maintain and visualize from polarity aspect.

In some embodiments, new attributes, such as polarity and polarity strength, can be introduced to model a social relation between users. For instance, for two users A and B, the social relation between them was traditionally represented as an ordered pair (A, B). According to some embodiments, the social relation may be represented as (A, B, P), where the parameter P represents the polarity of the relation. For example, the sign of the value of P may represent the polarity between two users, and the size of the value of P may represent the strength of the polarity.

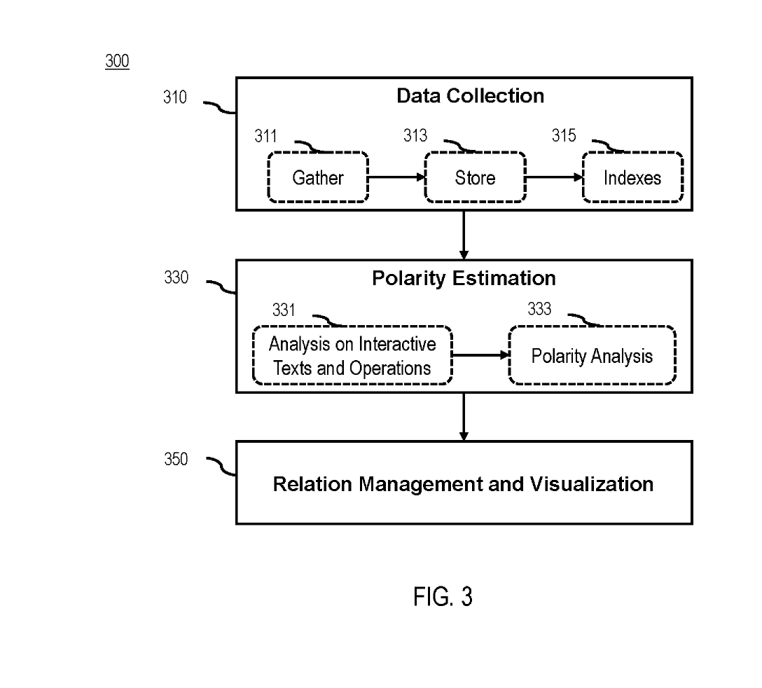

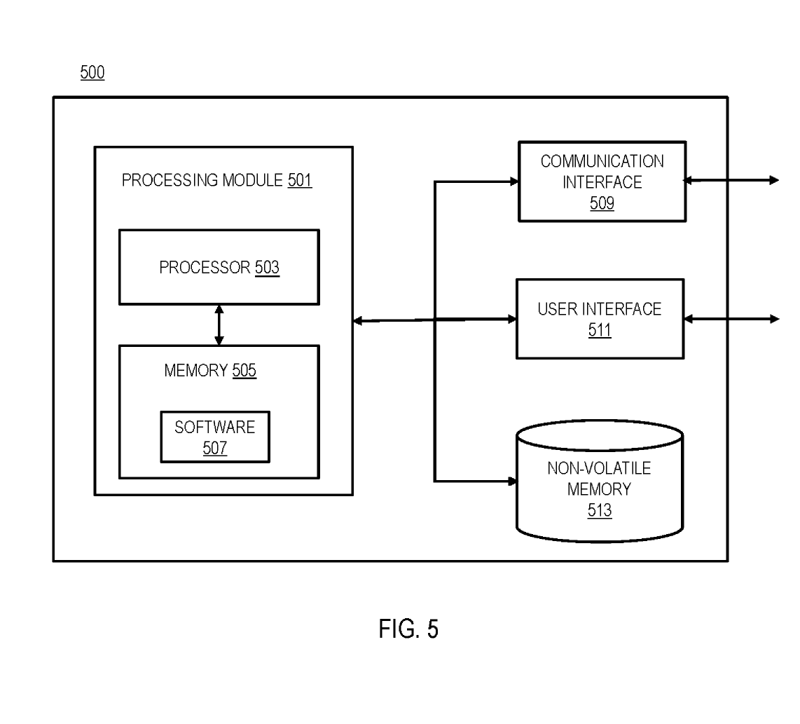

FIG. 3 illustrates an outline of a procedure for social relation analysis and management. In such an embodiment, the process 300 is performed by one or more devices (such as the SNS provide 107, the UE 101, or the social relation management server 111), and is implemented in, for instance, a chip set including a processor and a memory as shown in FIG. 5. As such, the computing device may provide means for accomplishing various parts of the process 300 as well as means for accomplishing other processes in conjunction with other components.

As shown in FIG. 3, an overall procedure of social relation analysis and management mainly comprises three phases, including a phrase 310 for data collection, a phrase 330 for polarity estimation, and a phrase 350 for relation management and visualization. Given online behavior contents of two users, the main task for social relation analysis is to estimate the polarity and strength of the social relation between the two users. Let u and v represent the two users in an online social network. Before introducing the approach for social relation analysis, we make some definitions first as follows.

ms(u,v): is a message exchanged between two users.

cm(u,v): is a comment exchanged between two users.

rd(u,v): is a redirection exchanged between two users.

br(u,v): is a browse exchanged between two users.

agr(u,v): is an explicit agreed operation exchanged between two users, such as collecting information, supporting information, etc.

dagr(u,v): is an explicit disagree operation exchanged between two users, such as cancelling account, cancelling contents, vote against users, etc.

In the phase 310, data associated with interactions between two users (denoted as u and v) in a social network are collected for social relation analysis. The data may be collected from online social information sharing and communication services, such as microbloging, blogs, instant messages, social networks, reviews etc. For example, a crawler may be used to gather (311) related information as much as possible from internetwork, such as comments cm(u,v), message ms(u,v), browses br(u,v), redirect messages rd(u,v), agree operations agr(u,v), and disagree operations dagr(u,v), etc. This information may reflect the characteristics of interactions between user u and v. The gathered data may be stored (313) into a database, and indexed (315) for further computations. Contexts associated with respective interactions may be also stored for facilitating social relation analysis.

In the phase 330, the polarity of the social relation between the user u and v is estimated based on the collected interactive data. In the real life, a polarity of a relationship can be easily identified to separate good relationships from poor relationships according to off-line social interactions between individuals. For example, in an off-line social relation analysis, friendly behaviors such as “sweet smile”, “warm hug”, “encouraging words” and “tender care” are always considered as indicators for good relations; while on the contrary, impolitely or indifferently behaviors, such as “angry face”, “hard beat”, “heavy scold”, and “indifference words” are always considered as indicators for bad relations. Just like the off-line social relation analysis, the polarity of the online interactions may be also identified via obvious features in online interactions.

In calculation, a polarity could be measured from several aspects, such as the aspects of texts and operations. In some embodiments, interactive texts and operations may be analyzed (331) to identify polarities of texts and operations. The polarities of texts and operations may be synthesized for analyzing (333) the polarity of social relation. In the aspect of text interactions, the polarity is mostly expressed by “sentiment words”. For example, the word “good” in a text usually means a positive interaction, while the word “bad” in a text usually means a negative interaction. In a case where many positive expressions appear in the texts exchanged between two users, it is likely that the two users share a good relation. In contrast, if negative expressions dominate the interactions, the corresponding relation is always bad. Thus, the polarity of social relations can be estimated by using text analysis.

In an exemplary embodiment, sentiments words in texts may be extracted from interaction data, and then assigned with polarities. For example, by traversing all interaction texts between user u and v, all of the sentiment words may extracted from the texts, forming a set denoted as SW(u,v), where each element denoted as sw represents a single sentiment word. Each sentiment word may be assigned with a polarity according to a pre-constructed sentiment word library, which is always a mapping between items and corresponding polarities. For example, the sentiment word dictionary may be a key-value set, with each pair denoting a sentiment word and corresponding polarity sign and strength. For example, a set “good, +1” may mean a positive word “good”, a set “lovely, +3” may mean a very positive word “lovely”, a set “bad, −1” may mean a negative word “bad”, and “hate, −3” may mean a very negative word “hate”.

The polarities of all the sentiment words may be summed up, to derive a polarity of whole interaction texts. For example, the polarity of whole interaction texts Pₜₑₓₜ (u, v) may be calculated according to equation (1):

Pₜₑₓₜ(u,v)=Σpl(sw),sw∈SW(u,v) (1)
where the pl function is defined as an assignment of polarity for an individual sentiment word, which could be either positive or negative.

In the aspect of operation interactions, the polarity is mainly conveyed by the reasons of concrete operations. For example, operations “browse”, “comment”, “vote” usually express a positive attitude towards a target user, while operations “blackball”, “shielding”, “deleting” usually represent a negative attitude towards a target user. Hence, it can be anticipated that there may exist more positive interactions when two users have a good relation, and vice visa.

In an exemplary embodiment, interactive operations may be extracted from the collected interaction data, and then assigned with polarities. For example, the extracted operations may be stored as a set OP, which may include all sentiment operations, such as commenting, messaging, content-redirecting, voting, disagreeing, etc. Each element op in the set OP represents a single operation.

Each operation may be assigned with a polarity according to a pre-constructed sentiment operation library, which is always a mapping between items and corresponding polarities. In some embodiments, the sentiment operation library (OPL) may be constructed by virtue of human annotators, to determine whether an operation is positive or negative. For example, all common user interactive operations in SNS services may be collected for an OPL, such as “follow a user”, “follow a user's topic”, “cancel following a user”, “vote for a user's status”, “disagree with a user' comment”, “delete a friend”, “forward a message”, etc. Then, a group of human annotators that have experiences in using the mentioned different kind of operations in SNS services can be invited to label each operation with tag. For example, for each interactive operation opl in the OPL, ask the human annotators to read, understand using their past experiences of SNS services, and identify whether the operation opl indicate a positive or negative relation between two users. If a human annotator agrees that the operation opl means a positive interaction, then it is assigned a “positive” tag, otherwise assigned a “negative” tag. For example, the operation “following a friend” may be given a tag “positive,+1”, while the operation “disagree with a user's comment” may be attached a tag “negative,−1”. In some embodiments, the operation polarity labeling task may be performed as a multi-level tagging, which means the tags could be mapped to more than two polarities according to the requirements of specific services, such as “very positive,+2”, “positive,+1”, “negative,−1” and “very negative,−2”, etc. To avoid labeling bias, each operation opl in OPL is labeled with the tag that reaches the largest agreement among all human annotators.

For each extracted sentiment operation op in OP, a polarity may be identified according to the pre-constructed sentiment operation library OPL. For example, for an extracted operation op, the OPL may be searched to find the corresponding polarity score which indicates the polarity and strength of the operation. For example, an operation op “following a user” may be fined in OPL to be mapped into a tag “very positive, +2”, while an operation “cancel following a user” may be mapped into a tag “very negative, −2”.

The polarities of all the operations may be summarized to derive a polarity of whole interaction operations, which represents a synthetic conclusion of the whole sentiment orientation in the operation aspect. For example, the polarity of whole interaction operations Pₒₚ (u, v) may be calculated according to equation (2),

Pₒₚ(u,v)=Σpl′(op),op∈OP(u,v) (2)
where the pl′ function is defined as an assignment of polarity for an individual operation, which could be either positive or negative.

Based on the polarities of texts and operations, an overall polarity of the social relation between u and v can be determined (333), to indicate whether the social relation between the first user and the second user is positive, negative, or neutral. For example, the polarity of social relation P(u, v)may be calculated according to equation (3),

P(u,v)=α×Pₜₑₓₜ(u,v)+β×Pₒₚ(u,v) (3)
Where, parameters α and β are weights of the corresponding aspects, which is used to balance between the texts and operations factors. In practice, these parameters could be tuned for different scenario and applications. Similar as the operation polarity, a polarity of social relation may be divided into more than two levels. For example, very positive, positive, negative, very negative.

In some embodiments, P(u, v) may be calculated to represent a symmetric relation. That means the relation is the same from the point of view of user u and user v.

In other embodiments, P(u, v) may be calculated to represent an asymmetric relation, which means the attitude of user u to user v may be different from the attitude of user v to user u. In that case, P(u, v) may be used to represent a social relation between user u and v from the point of user u's view. It may be calculated based on polarities of interactions texts and operations originated from user u. Accordingly, another parameter P(v, u) may be used to represent a social relation between user v and u from the point of user v′s view. It may be calculated based on polarities of interactions texts and operations originated from user v.

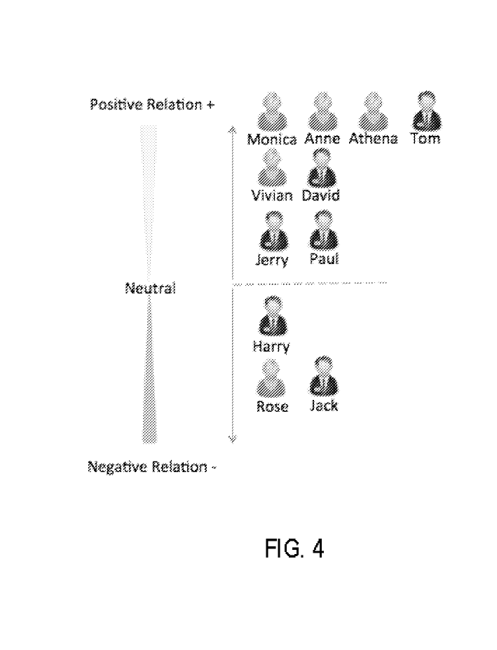

In the phase 350, the polarity analysis result may be displayed to facilitate user's social relation management. In some embodiments, concerning to a certain user, the associated users may be listed according to their social polarities shared with the certain user. For example, the analysis result may be visualized and demonstrated in a direct and understandable manner, as shown in FIG. 4. In FIG. 4, a certain user's friends are classified into two groups according to their social polarities. Persons listed above the dotted line share a positive relation with the user, while persons listed below the dotted line share a negative relation with the user. In addition, persons in each group are listed in several grades according to the corresponding strength of polarity. For example, the farther a certain person is positioned from the division dotted line, the larger the polarity strength of the shared relation is.

The polarity analysis result may be also utilized for social relation management. This may help to get more adequate understanding of user relations and user behaviors, which as a result provides more evidence for more accurate recommendations, decision support, result rankings and customized user experience designs, and also for user relation predictions and user relation trends predictions. For example, through an automatic polarity analysis on historical behaviors, managers or individual users don't need to manually identify the positive and negative relations in their social circles. The visualization of polarity analysis result makes it efficient to read and manage social relations of users. Through visualization of social relation polarities, users could determine the good relations that need to be carefully maintained or bad relations that should be repaired or discarded.

In some embodiments, for different social relations, a SNS provider could design different recommendation schema or promote strategies. As commonly understood, one is usually glad to receive information from best friends, but not from someone disliked. Accordingly, recommendations may be made effectively based on the polarity of social relation. For example, for positive social relations, the SNS provider may give more information exposures, such as recommending new updates, or listing activity notices etc. On the contrary, for negative social relations, the SNS provider may need to design a more in-direct promotion measures so as not to cause annoys of clients.

Now reference is made to FIG. 5 illustrating an example block diagram of an apparatus 500 in which various embodiments of the invention may be applied. This may be embodied in a SNS provider, a user equipment (UE), or a third party, such as a server for social relation management. The general structure of the apparatus 500 comprises a processing module 501, a communication interface module 509 coupled to the processing module 501. The apparatus 500 may further comprise a user interface module 511 coupled to the processing module 501, and a non-volatile memory 513 coupled to the processing module 501. Also the communication interface module 509, the user interface module 511, and the nonvolatile memory 513 may communicate with each other.

The processing module 501 comprises a processor 503 and a memory 505. The processing module 501 further comprises software 507 stored in the memory 505 and operable to be loaded into and executed in the processor 503. The software 507 may comprise one or more software modules and may be in the form of a computer program product. The processing module 501 may comprise separate processing and memory areas for application software or data, and for normal operations of the apparatus 500.

The communication interface module 509 may be a wire communication module, or a wireless communication module, such as a WLAN, Bluetooth, GSM/GPRS, CDMA, WCDMA, or LTE (long term evolution) radio module. The communication interface module 509 may be integrated into the apparatus 500 or into an adapter, card or the like that may be inserted into a suitable slot or port of the apparatus 500. Although FIG. 5 shows one communication interface module 509, the apparatus 500 may comprise a plurality of communication interface modules 509.

The processor 503 may be, e.g., a central processing unit (CPU), a microprocessor, a digital signal processor (DSP), a graphics processing unit, or the like. FIG. 5 shows one processor 503, but the apparatus 500 may comprise a plurality of processors.

The memory 505 may comprise for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 500 may comprise a plurality of memories. The memory 505 may be constructed as a part of the apparatus 500 or it may be inserted into a slot, port, or the like of the apparatus 500 by a user. The memory 505 may serve the sole purpose of storing data, or it may be constructed as a part of an apparatus serving other purposes, such as processing data or taking malware detections. The non-volatile memory 513 may be for example a flash memory and may serve for example the purpose of receiving and storing software updates. The non-volatile memory 513 may be constructed as a part of the apparatus 500 or it may be inserted into a slot, port, or the like of the apparatus 500 by a user.

The user interface module 511 may comprise circuitry for receiving input from a user of the apparatus 500, e.g., via a keyboard, graphical user interface shown on a display of the apparatus 500, speech recognition circuitry, or an accessory device, such as a headset, and for providing output to the user via, e.g., a graphical user interface or a loudspeaker.

A skilled person appreciates that in addition to the elements shown in FIG. 5, the apparatus 500 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the apparatus 500 may comprise a disposable or rechargeable battery (not shown) for powering the apparatus 500 when external power if external power supply is not available.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should be appreciated that at least some aspects of the exemplary embodiments of the inventions may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

Various features of various embodiments of the invention may provide various advantages. By checking malwares in both offline and at runtime according to some embodiments, one may reduce risk of malwares to minimum. During an offline malware detection, at least one of static complete calling maps, partial calling maps and calling maps at different time may be checked to find malware. During a real-time malware detection, calling map patterns may be checked to find security leaks caused by function callings. Furthermore, data accessing behaviors may be checked to find risky local data access, especially abnormal access that are different from the past. Furthermore, through a check on networking behaviors of an application, the inbound traffic of the application may be checked to find potential intrusions, and outbound traffic of the application may be checked to figure out possible infection caused by some sudden attacks, e.g., making the computing device to become a bot. As such, it is possible to handle malwares that steals and sells user information, manipulates content delivery, sends spam, or a sudden intrusion on computing devices, and provide a comprehensive detection and protection.

The present invention includes any novel feature or combination of features disclosed herein either explicitly or any generalization thereof. Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

1. A method, comprising:
collecting data associated with interactions between a first user and a second user in a social network; and
estimating a polarity of a social relation between the first user and the second user based on the collected data, to indicate whether the social relation between the first user and the second user is positive, negative, or neutral.

2. A method of claim 1, wherein estimating the polarity of the social relation further comprises:
identifying a polarity of at least one of texts and operations involved the interactions; and
estimating the polarity of the social relation based on the identified polarity.

3. A method of claim 2, further comprises:
extracting at least one sentiment word from the texts involved in the interactions;
identifying a polarity of each of the at least one sentiment word; and
synthesizing the identified polarity of sentiment word.

4. A method of claim 3, further comprises:
extracting at least one operation involved in the interactions;
identifying a polarity of each of the at least one operation; and
synthesizing the identified polarity of operation.

5. A method of claim 4, wherein the polarity of the social relation is estimated by combining the synthesized polarity of sentiment word and the synthesized polarity of operation.

6. A method of claim 1, wherein the polarity of the social relation is estimated to further indicate the strength of the polarity of the social relation.

7. A method of claim 1, further comprises:
managing the social relation between the first user and the second user based on the estimated polarity of the social relation.

8. An apparatus comprising:
at least one processor; and
at least one memory including computer program code,
the at least one memory and the computer program code configured to, with the at least one processor, cause the apparatus to perform at least the following:
collect data associated with interactions between a first user and a second user in a social network; and
estimate a polarity of a social relation between the first user and the second user based on the collected data, to indicate whether the social relation between the first user and the second user is positive, negative, or neutral.

9. An apparatus of claim 8, wherein the estimation of the polarity of the social relation comprises
identifying a polarity of at least one of texts and operations involved the interactions; and
estimating the polarity of the social relation based on the identified polarity.

10. An apparatus of claim 9, wherein the apparatus is further caused to:
extract at least one sentiment word from the texts involved in the interactions;
identify a polarity of each of the at least one sentiment word; and
synthesize the identified polarity of sentiment word.

11. An apparatus of claim 10, wherein the apparatus is further caused to:
extracting at least one operation involved in the interactions;
identifying a polarity of each of the at least one operation; and
synthesizing the identified polarity of operation.

12. An apparatus of claim 11, wherein the polarity of the social relation is estimated by combining the synthesized polarity of sentiment word and the synthesized polarity of operation.

13. An apparatus of claim 8, wherein the polarity of the social relation is estimated to further indicate the strength of the polarity of the social relation.

14. An apparatus of claim 8, wherein the apparatus is further caused to:
manage the social relation between the first user and the second user based on the estimated polarity of the social relation.

15. A computer-readable storage medium carrying one or more sequences of one or more instructions which, when executed by one or more processors, causing an apparatus to perform a method of claim 1.

16. (canceled)

17. (canceled)
